(19) United States
(12) Patent Application Publication
(10) Pub. No.: US 2024/0120732 A1
(43) Pub. Date: Apr. 11, 2024

(54) SYSTEM AND METHOD FOR POWER STATION CONTROL BASED ON TOTAL HARMONIC DISTORTION

(71) Applicant: Champion Power Equipment, Inc., Santa Fe Springs, CA (US)

(72) Inventors: Greg Pauken, Hartland, WI (US); James J. Dehn, Brookfield, WI (US); Zhikun Zhong, New Berlin, WI (US); Artur Starosciak, Greendale, WI (US)

(21) Appl. No.: 18/334,787

(22) Filed: Jun. 14, 2023

Related U.S. Application Data
(60) Provisional application No. 63/378,448, filed on Oct. 5, 2022.

(51) Int. Cl. H02H 7/122; H02H 1/00; H02M 7/00

(52) U.S. Cl. CPC H02H 7/122; H02H 1/0007; H02M 7/003

(57) ABSTRACT

A power station includes an inverter to convert DC power to AC power, an onboard battery system configured to provide DC power to the inverter, and at least one AC power output receptacle configured to receive AC power from the inverter and provide the AC power to a load. The power station also includes a control system programmed to determine a total harmonic distortion (THD) of the AC power provided to the at least one AC power output receptacle from the inverter and a display operated by the control system to indicate the THD.

### CROSS-REFERENCE TO RELATED APPLICATIONS

The present application is a non-provisional of and claims priority to U.S. Provisional Patent Application Ser. No. 63/378,448, filed Oct. 5, 2022, the disclosure of which is incorporated herein by reference in its entirety.

### BACKGROUND OF THE INVENTION

Embodiments of the present invention relate to total harmonic distortion (THD) control of inverter generator systems.

Inverter generator systems are useful as mobile or backup power sources. Inverter generator systems may include gas inverter generators powered by gaseous fuels or gasless inverter generators/inverter power stations powered by battery systems. Regardless, they can provide power in locations without access to the utility grid or when natural disasters, extreme weather events, or other conditions result in a power outage.

Battery systems can store electrical energy for use in locations without access to the utility grid or when a power outage occurs in the grid. Battery system users can charge their battery systems with energy from various sources such as, for example, the utility grid using a converter or rectifier that changes alternating current (“AC”) power into direct current (“DC”) power. Alternatively, such users may elect to charge their battery systems with energy from carbon-free renewable energy sources, the use of which generally reduces dependence on fossil fuels and lowers energy bills. As an example, solar panels can charge battery systems to provide a renewable source of stored energy independent from the utility grid, which is convenient for many mobile and off-grid applications. Battery systems can include batteries connected in series or in parallel to expand capacity in terms of voltage and/or current and can power electrical devices that require AC power using an inverter that transforms DC power into AC power.

An inverter can simulate a sine wave in an AC output waveform from battery systems when converting DC power into AC power. Unfortunately, an inverter typically introduces harmonic frequencies into the waveform and produces a distorted or non-sinusoidal waveform. Harmonics are sinusoidal components of the non-sinusoidal waveform having frequencies at integer multiples of the first harmonic frequency, or fundamental frequency. The THD quantifies the distortion in the waveform. THD is commonly expressed as a percent ratio of the root mean square (RMS) amplitudes of a set of higher harmonic frequencies to the RMS amplitude of the fundamental frequency. The higher the percentage of THD, the more distortion is present in the electrical system. Non-linear loads that draw current in non-sinusoidal waveforms can increase distortion of the waveform.

Harmonic distortion can cause various conditions that are detrimental to electrical equipment. That is, harmonics create undesirable current increases that can lead to instability, overheating, hysteresis, and eddy current loss in transformers and motors, interference with communication transmission lines, and voltage distortion such as, for example, higher voltage peaks and unexpected zero-crossing. Increased temperature and interference from harmonics can reduce the service life of electrical equipment. Electronic equipment with power elements that rapidly transition between fully-on and fully-off states are especially vulnerable to harmonic distortion due to their non-linear nature. Computers and related equipment, such as, for example, programmable controllers, often require an AC source with no more than 5% THD. Unfortunately, many gas inverter generators produce AC power with a THD greater than 10% depending on the type and amount of load.

Therefore, it would be desirable to provide a power station that can determine and indicate or display whether a THD is above a predetermined level and/or automatically shut off its AC power output if the THD reaches or exceeds the predetermined level.

### BRIEF STATEMENT OF THE INVENTION

Embodiments of the present invention relate to a power station capable of monitoring its THD and taking action upon reaching specific conditions.

In accordance with one aspect of the invention, a power station includes an inverter to convert DC power to AC power, an onboard battery system configured to provide DC power to the inverter, and at least one AC power output receptacle configured to receive AC power from the inverter and provide the AC power to a load. The power station also includes a control system programmed to determine a total harmonic distortion (THD) of the AC power provided to the at least one AC power output receptacle from the inverter and a display operated by the control system to indicate the THD.

In accordance with another aspect of the invention, a non-transitory computer readable storage medium has stored thereon a computer program for controlling the power output of a power station based on a total harmonic distortion (THD) of the power station. The computer program includes instructions that cause a processor to determine the THD of the power station when AC power is output through at least one power output receptacle of the power station and shut off the AC power to the at least one power output receptacle when the THD is above a preset level.

In accordance with yet another aspect of the invention, a power station includes an onboard battery system, at least one power output receptacle, an inverter powered by the onboard battery system to provide AC power to the at least one power output receptacle, and a control system. The control system is programmed to determine a total harmonic distortion (THD) of the power station when AC power is output through the at least one power output receptacle and to automatically shut off the AC power to the at least one power output receptacle when the THD is above a preset level.

These and other advantages and features of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is an upper-right front perspective view of a power station, according to an embodiment of the invention.

FIG. 2 is a partial lower-left rear perspective view of the power station of FIG. 1 with power receptacle covers exploded from the power station, according to an embodiment of the invention.

FIG. 3 is a front view of a control panel for the power station of FIG. 1, according to an embodiment of the invention.

FIG. 4 is an upper-right front perspective view of an expansion battery for the power station of FIG. 1, according to an embodiment of the invention.

FIG. 5 is a lower-left rear perspective view of the expansion battery of FIG. 4, according to an embodiment of the invention.

FIG. 6 is a rear view of the power station of FIG. 1 coupled to first and second expansion batteries of the type shown in FIG. 4, according to an embodiment of the invention.

FIG. 7A is an upper-left front perspective view of the power station and expansion batteries of FIG. 6 in a stacked configuration with the first expansion battery positioned on the power station, a pair of stack adaptors positioned on handles of the first expansion battery, and the second expansion battery positioned on the first expansion battery via the pair of stack adaptors, according to an embodiment of the invention.

FIG. 7B is an exploded partial perspective view of the first and second expansion batteries and stack adaptors of FIG. 7A, according to an embodiment of the invention.

FIG. 8A is a power station display of the control panel of FIG. 3, according to an embodiment of the invention.

FIG. 8B is a power station display of the control panel of FIG. 3 indicating that a THD shield is enabled and AC output is off, according to an embodiment of the invention.

FIG. 8C is a power station display of the control panel of FIG. 3 indicating that the THD shield is enabled and a THD is above a fault level, according to an embodiment of the invention.

FIG. 8D is a power station display of the control panel of FIG. 3 indicating that the THD shield is disabled and the THD is below the fault level, according to an embodiment of the invention.

FIG. 8E is a power station display of the control panel of FIG. 3 indicating that the THD shield is disabled and the THD is above a fault level, according to an embodiment of the invention.

FIG. 9 is a block diagram of a power station assembly, according to an embodiment of the invention.

FIG. 10A is an upper-left front perspective view of a battery charger for the expansion battery of FIG. 4, according to an embodiment of the invention.

FIG. 10B is a lower-left rear perspective view of the battery charger of FIG. 10A, according to an embodiment of the invention.

FIG. 11 is a flow chart illustrating a technique performed by a control system of the power station of FIG. 1 for controlling the AC power output by the power station based on a THD of the power station, according to an embodiment of the invention.

### DETAILED DESCRIPTION

The operating environment of the invention is described herein with respect to a portable power station. However, those skilled in the art will appreciate that the invention is equally applicable for use with gas inverter generators and nonportable power stations. Furthermore, while the invention is described with respect to a battery-operated power station having an inverter that converts DC power to AC power, embodiments of the invention are equally applicable for use with battery-operated power stations having a DC-to-DC power converter.

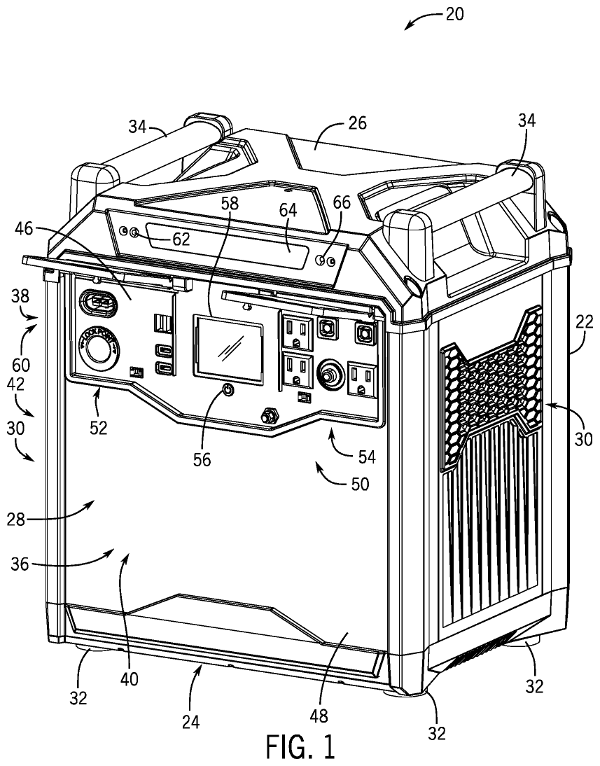

Referring to FIG. 1, a portable power station for providing power to electrical devices (not shown in FIG. 1) is shown, according to an embodiment of the invention. The power station 20 includes a housing 22 having a base 24, a top wall 26, and a plurality of sidewalls 28 that surround and protect internal components of the power station 20. Cooling vents 30 are positioned in one or more of the sidewalls 28 to provide cooling air to components within the housing 22. The power station 20 may include a plurality of feet 32 extending downward from the base 24 to provide a stable foundation and to raise the housing 22 slightly off the floor or ground. The power station 20 may include a pair of carrying handles 34 extending upward from the top wall 26 to lift and carry the power station 20. While the carrying handles 34 are shown in FIG. 1 as being oval-shaped, in various embodiments, the carrying handles 34 may have another shape that is comfortable to a user. A single person may be able to lift the power station 20 with one or both of the carrying handles 34, and thus the power station may provide a convenient mobile power source.

The power station 20 typically includes an onboard battery system 36 including one or more batteries (not shown in FIG. 1) and a control system 38 positioned within the housing 22. The onboard battery system 36 may include a rechargeable lithium-ion battery 40 with a chemistry of either nickel manganese cobalt (NMC) or lithium iron phosphate (LFP). The control system 38 may include a converter (not shown in FIG. 1) for converting a voltage from the onboard battery system 36 into another voltage required to operate the electrical devices. The control system 38 may include an inverter 42 to change DC power from the onboard battery system 36 into AC power supplied to the electrical devices. For example, the inverter 42 may provide single or three phase AC power at 50 Hz or 60 Hz. Accordingly, the power station 20 may be referred to as a gasless inverter generator 20.

The power station 20 is shown with a control panel 46 located on a front sidewall 48 of the power station 20. The control panel 46 controls operation of the power station 20 and connects to one or more electrical devices powered by the power station 20. The control panel 46 includes one or more power output receptacles 50 (for example, sockets) that receive electrical connections (for example, plugs) from the electrical devices. The power output receptacles 50 are generally powered by the onboard battery system 36 via the control system 38. The one or more power output receptacles 50 are shown as a plurality of DC power output receptacles 52 and a plurality of AC power output receptacles 54, with the inverter 42 providing AC power to the AC power output receptacles 54.

The control panel 46 includes a power button 56 to turn on and off the power station 20. The power station 20 is turned on/off by the power button 56 when pressed and held for a short period of time. When the power station 20 is on, the power button 56 can also turn the AC power output receptacles 54 on/off when pressed without being held. The control panel 46 may include a display 58, also referred to as a user display panel, to show operating characteristics of the power station 20. The display 58 is typically an automatic display 58 displaying one or more items of information that the control system 38 automatically stores and updates without user input and will be referenced as the automatic display 58 below. However, in some embodiments, the display 58 may also display one or more items of information that control system 38 does not automatically update or may be configured in a manner that requires a manual input from a user for all information updates. In some embodiments, the power button 56 illuminates the automatic display 58 each time it is pressed.

The automatic display 58 can display a battery level of the power station 20 to a person using the power station 20. Herein, the battery level of the power station 20 is also referred to as the energy level, charge level, or state of charge of the power station 20. The automatic display 58 may display the battery level in terms of percentages. As such, the battery level is also referenced herein as a percent battery level. The battery level of the onboard battery system 36 may correspond to the battery voltage.

The control system 38 is programmed to determine a THD associated with the AC power from the inverter 42 and to operate the automatic display 58 to indicate the THD to an operator. The automatic display 58 may indicate whether the THD is above a level that could damage sensitive electronic components powered by the inverter 42. High THD is generally caused by a high load on the AC power output receptacles 54 and/or by a low battery level powering the inverter 42. As the battery level drops, the AC power output can be too high for the inverter 42 to simulate a pure sine wave. In various embodiments, the battery level of the onboard battery system 36 corresponds to a voltage output from the battery. Thus, the THD may be determined based on power and voltage output from the power station 20.

The control system 38 may determine the power and voltage output from the power station 20 via measured voltage, current, and/or power values from one or more voltage, current, and/or power sensors (not shown) on the power station 20. Depending on the type of sensor used, the control system 38 may either utilize measured values from the sensors directly or calculate values based on the measured values. Thereafter, the control system 38 may determine the battery level based on the voltage of the onboard battery system 36 and calculate the percent battery level of the onboard battery system 36 at a point in time based on the determined battery level and the battery level capacity of the onboard battery system 36. The THD can therefore be reduced by unplugging one or more AC devices from the power station 20 and/or by charging the onboard battery system 36. If the power output is lower, the inverter 42 will be able to simulate a pure sine wave (for example, a waveform with a low THD) at a lower battery level and for a longer period of time prior to the onboard battery system 36 being recharged.

The control system 38 may be programmed with a THD shield 60 to automatically shut off AC power output from the AC power output receptacles 54 when the THD is above a predetermined level (for example, 5%). The THD shield 60 of the control system 38 may automatically shut off AC power output when the onboard battery system 36 has a battery level below a predetermined battery level, which can indicate that the THD is above a predetermined THD level. In various embodiments, at full AC load (for example, 1,600 Watts (1,600 W)), the THD will rise above 5% at less than 20-25% battery level remaining, and at low loads (for example, 100 W), the THD will not rise above 5% until the onboard battery system 36 is basically dead. Since a charged or partially charged battery might have low THD even at full load, the THD shield 60 could be configured to determine that the battery level of the onboard battery system 36 is lower than a predetermined battery level prior to determining if the THD requires shutting off AC power output. In various embodiments, the predetermined battery level is approximately 30% of a battery level of the onboard battery system 36 when the onboard battery system 36 is at 100% battery level or fully charged and the predetermined THD level is approximately 5%. The DC power output receptacles 52 can remain powered even if the AC power output receptacles 54 are shut off by the THD shield 60.

An overload reset button 62, also referred to as a THD shield button 62, can be pressed to re-energize the DC and AC power output receptacles 52, 54 if they have been shut off due to an electrical fault. The overload reset/THD shield button 62 may also provide a user input control to selectively enable the THD shield 60 while the automatic display 58 indicates whether the THD shield 60 is enabled or disabled. In various embodiments, a user may press the overload reset/THD shield button 62 once to re-energize both AC power output receptacles 54 and DC power output receptacles 52 after an overload fault and five times in three seconds to turn the THD shield 60 on or off. When the THD shield 60 is on and the THD rises above a predetermined level, also referred to as a THD fault level, the control system 38 shuts off AC power output to prevent damage to sensitive electronics. A user may press the overload reset/THD shield button 62 to restore AC power to the AC power output receptacles 54 following a THD shutoff. An LED light 64 that can illuminate a work area in front of the power station 20 is positioned above the control panel 46 adjacent the overload reset button 62 and an LED light button 66 that turns on the LED light 64.

In various embodiments, to restore AC output after the control system 38 shuts off power according to the THD shield 60, a user should charge the power station 20 (if possible), lower the AC running watts by unplugging one or more electrical devices, and press the overload reset button 62 to re-energize the AC power output receptacles 54. In various embodiments, to prevent control system 38 from shutting off power due to the THD shield 60, a user should maintain a high battery level in the onboard battery system 36, charge the power station 20 during use, unplug high current draw AC appliances to lower the AC running watts when the battery falls to near 30% charge capacity, and/or turn off the THD shield 60. In various embodiments, to turn the THD shield 60 off, a user should lower the AC running watts by unplugging one or more devices to limit increasing THD levels as the battery level depletes and press the THD shield button 62 five times within three seconds. When the THD shield 60 is disabled, the control system 38 will not shut off AC power output when the THD rises above the predetermined level. A user should monitor sensitive devices for abnormal operation and disconnect as necessary.

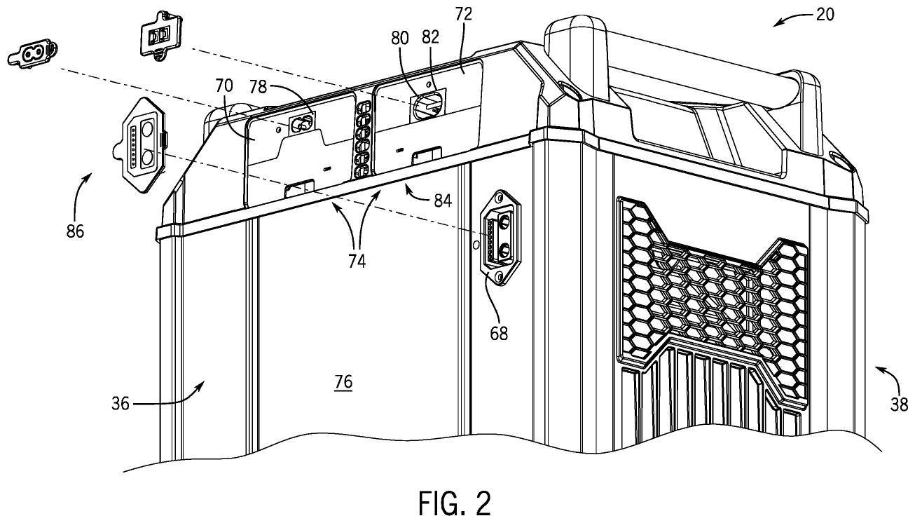

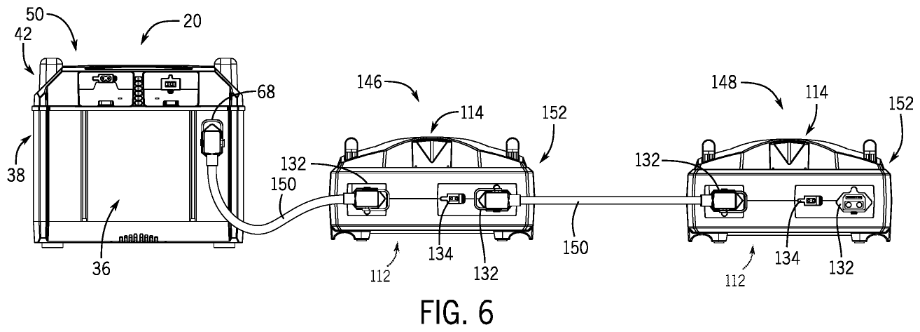

Referring now to FIG. 2, the backside of the power station 20 is shown with receptacle covers 86 exploded therefrom, according to an embodiment of the invention. The power station 20 includes an external battery port 68 to connect one or more expansion batteries (not shown in FIG. 2), as explained in more detail below with respect to FIG. 6. The power station 20 may couple to a single expansion battery or to a string of expansion batteries (for example, up to ten or more) to increase the battery or energy capacity and runtime of the power station 20. The control system 38 couples the onboard battery system 36 and the external battery port 68 to each of the power output receptacles 50 (FIG. 1).

FIG. 2 shows an AC charging module 70 and a DC charging module 72 that charge the onboard battery system 36 from an AC power source (not shown in FIG. 2) and a DC power source (not shown in FIG. 2), respectively. The AC charging module 70 and the DC charging module 72 are positioned within charging module slots 74 in the back sidewall 76 of the power station 20. Charging terminals (not shown in FIG. 2) are located within the charging module slots 74 and electrically connect the AC and DC charging modules 70, 72 to the power station 20 when the charging modules 70, 72 are inserted into the charging module slots 74. If a charging module with a different electrical configuration is desired, the AC charging module 70 and the DC charging module 72 can be removed from the charging module slots 74 for replacement.

The AC and DC charging modules 70, 72 have respective AC and DC power inlet receptacles 78, 80 each coupled to the onboard battery system 36 to recharge the power station 20. The AC charging module 70 may include a rectifier (not shown in FIG. 2) to convert AC power from an AC source into DC power supplied to the onboard battery system 36. The AC power inlet receptacle 78 may charge the power station 20 from a traditional wall outlet (not shown in FIG. 2) connected to the utility grid (not shown in FIG. 2). The DC power inlet receptacle 80 may include an APP (Anderson Power Pole) input port 82 that can support DC charging from one or more solar panels (not shown in FIG. 2). The DC charging module 72 may include a maximum power point tracking (MPPT) module 84 to optimize charging of the onboard battery system 36 from the solar panels. The receptacle covers 86 protect the external battery port 68, the AC power inlet receptacle 78, and the DC power inlet receptacle 80 from moisture, dirt, and other debris.

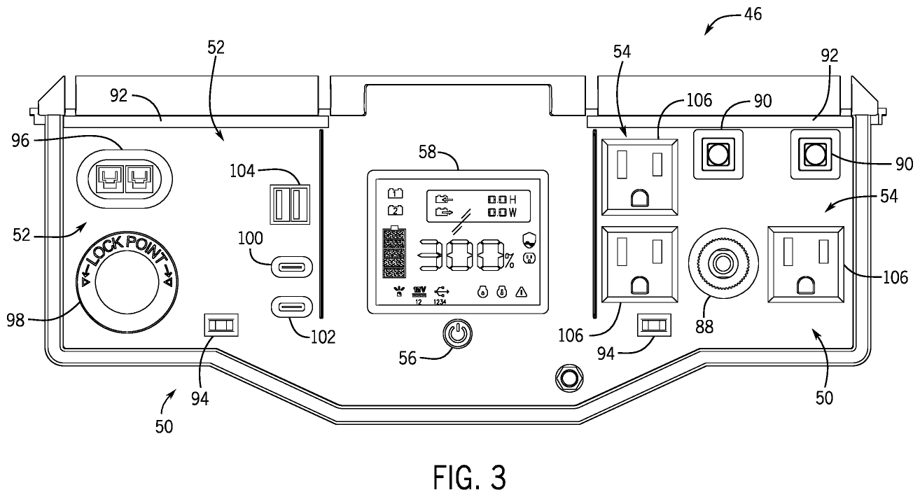

Referring now to FIG. 3, the control panel 46 of the power station 20 of FIG. 1 is shown, according to an embodiment of the invention. The control panel 46 includes a power button 56 to turn on and off the power station 20 and to illuminate the automatic display 58. The automatic display 58 can indicate the battery level available from the onboard battery system 36 and any connected expansion batteries (not shown in FIG. 3) to a user. The control panel 46 also includes a circuit breaker 88, linking kit connection ports 90, and a plurality of selectively openable protective covers 92. The circuit breaker 88 protects the power station against electrical overloads and can be pressed by an operator to reset power to the power output receptacles 50. The linking kit connection ports 90 are used to electrically couple AC power outputs from the linking kit connection ports 90 of two power stations 20 to a linking kit or module (not shown in FIG. 3) that is able to provide an increased AC power output. The protective covers 92 are hinged to the control panel 46 to selectively cover the power output receptacles 50 and are latched in closed positions by depressible cover locks 94.

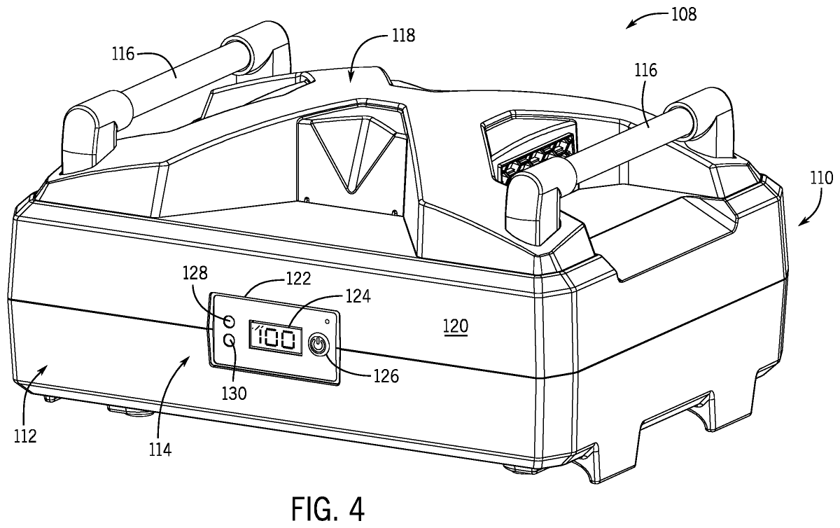

The control panel 46 is shown with a plurality of DC power output receptacles 52 that are powered by the onboard battery system 36 and/or any connected expansion batteries 108 (FIG. 4) and that may output different levels of voltage and current. For example, an APP (Anderson Power Pole) port 96 may supply electrical power for operation of 12-volt (12V) DC, 20-amp (20 A) electrical loads. A regulated automotive port 98 may supply electrical power for operation of 12V DC, 10 A electrical loads. A plurality of Universal Serial Bus (USB) ports may provide power to devices such as, for example, cellphones, laptops, and tablets. A USB Type-C+Power Delivery (PD) port 100 may supply 5V/9V/12V/15V/20V DC, 3 A Fixed or 3.3V-21V DC according to the Programmable Power Supply (PPS) protocol to provide power up to a maximum of 60 watts (60 W) with PD compatible devices. A USB Type-C+Quick Charge (QC) port 102 may supply 3.6V-12V DC, 3 A Fixed (for example, 5V/9V, 3 A Fixed or 12V, 2.5 A Fixed) or 3.6V-12V DC PPS to provide power up to a maximum of 30 W with QC 3.0 compatible devices. USB Type-A ports 104 may supply a maximum of 5V DC, 2.1 A.

The control panel 46 is also shown with a plurality of AC power output receptacles 54 that are powered by the onboard battery system 36 and/or any expansion batteries 108. For example, National Electrical Manufacturers Association (NEMA) 5-15R ports 106 may be used to supply electrical power for operation of 120V AC, 15 A, single phase, 60 Hz electrical loads. However, the AC power output receptacles 54 may provide power from the inverter at any suitable current (for example, any integer or half-integer value from 2.5 A to 30 A) and voltage (for example, any integer value from 110V to 120V AC or any integer value from 220V to 250V AC). In various embodiments, the power button 56 turns on the inverter 42 (FIG. 1) to power the AC power output receptacles 54 while the DC power output receptacles 52 are configured to always receive power.

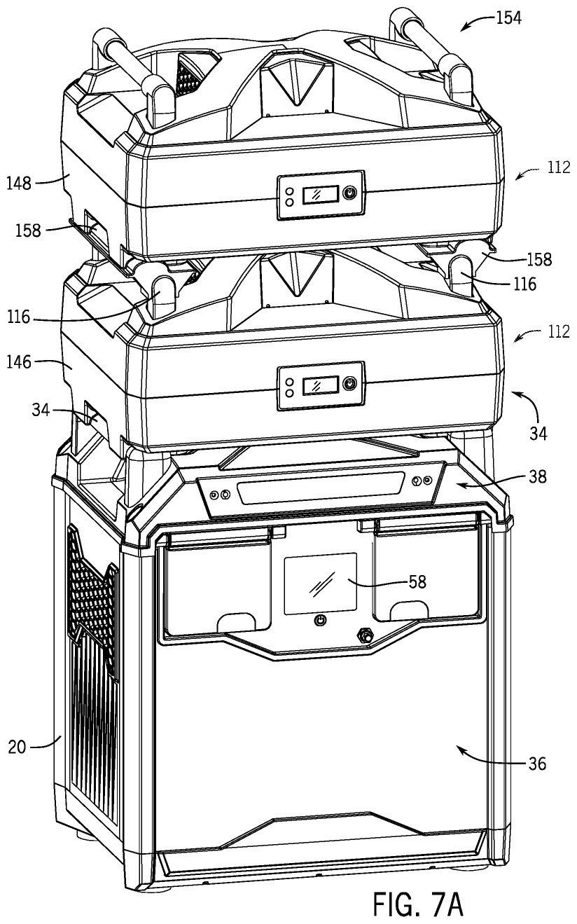

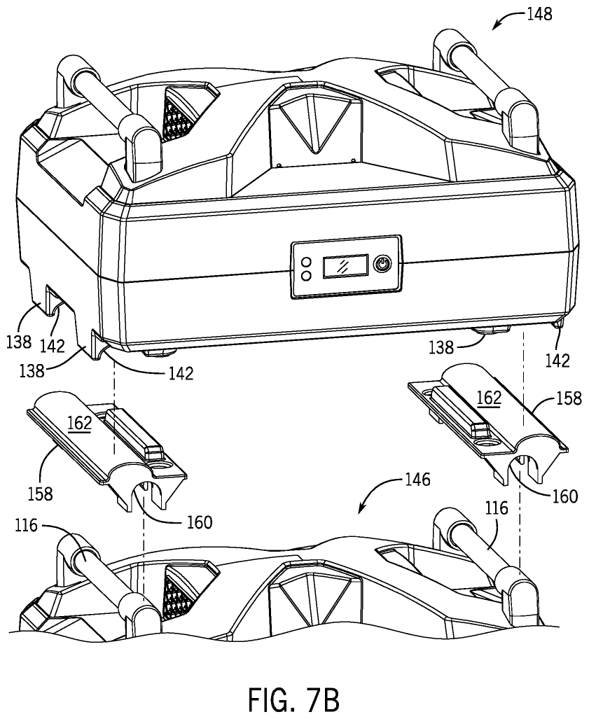

Referring now to FIG. 4, an expansion battery 108 for supplying additional power to the power station 20 of FIG. 1 is shown, according to an embodiment of the invention. The expansion battery 108 may include a housing 110 with a battery system 112 including one or more batteries and a control system 114 positioned within the housing. In some embodiments, the battery system 112 is a rechargeable lithium-ion battery with a chemistry of either nickel manganese cobalt (NMC) or lithium iron phosphate (LFP). The control system 114 operates the expansion battery 108 and may include a converter (not shown in FIG. 4) for converting the voltage of battery system 112 into another voltage supplied to the power station 20. A pair of carrying handles 116 extend upward from a top surface 118 of the housing 110 and can be used to lift the expansion battery 108 or to support another expansion battery 108 resting on the handles 116 when in a stacked configuration, as explained in more detail below with respect to FIGS. 7A and 7B.

A front sidewall 120 of the housing 110 includes a display 122 that shows operating characteristics of the expansion battery 108. The display 122 is generally an automatic display 122 displaying one or more items of information that the control system 114 automatically stores and updates without user input and will be referenced as the automatic display 122 below. However, in some embodiments, the display 122 may also display one or more items of information that the control system 114 does not automatically update or may be configured in a manner that requires a manual input from a user for all information updates. The automatic display 122 includes a fuel or battery gauge 124 that shows a remaining battery level for the expansion battery 108 in terms of percentages. As indicated above with respect to FIG. 1, the remaining battery level may correspond to the battery voltage, and the battery level percentage value is also referenced as a percent battery level. The control system 114 may determine the percent battery level via a measured value from a voltage sensor (not shown) on the expansion battery 108. Depending on the type of voltage sensor, the control system 114 may either utilize measured values from the voltage sensor as voltage values/battery levels or calculate battery levels based on the measured values. Thereafter, the control system 114 may determine the battery level based on the voltage of the battery system 112 and calculate the percent battery level of the battery system 112 at a point in time based on the determined battery level and the battery level capacity of the battery system 112.

The automatic display 122 may also display fault codes when faults occur such as high or low temperature faults, battery or circuitry communication faults, or a battery management system (BMS) fault, as non-limiting examples. A display button 126 turns on/off the automatic display 122 and illuminates the fuel gauge 124. A discharging indicator LED 128 will illuminate red when the automatic display 122 is turned on and the expansion battery 108 is discharging to the power station 20. A charging indicator LED 130 will illuminate green when the automatic display 122 is turned on and the expansion battery 108 is charging.

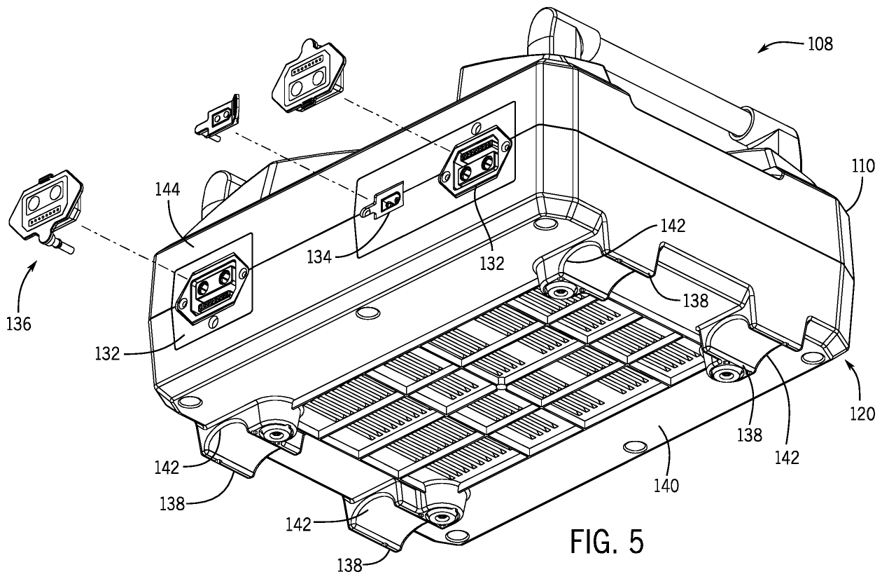

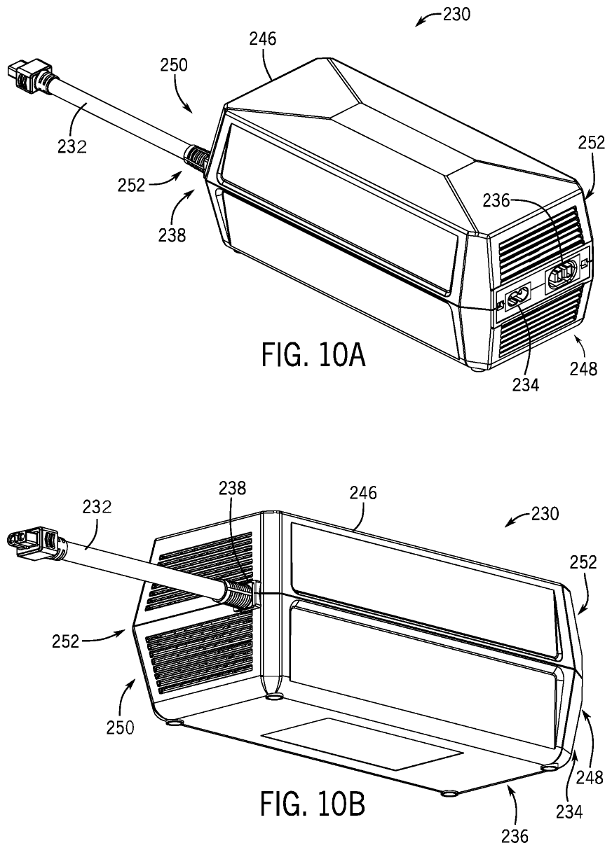

Referring now to FIG. 5, a rear view of the expansion battery 108 is shown with receptacle covers 136 exploded therefrom, according to an embodiment of the invention. The expansion battery 108 includes a pair of battery connection ports 132. Each of the battery connection ports 132 connect the expansion battery 108 to the power station 20 or to another expansion battery 108. The expansion battery also includes a charging module input port 134 configured to connect to a power cord of a charging module (not shown in FIG. 5) that is configured to charge the expansion battery 108, as explained in more detail with respect to FIGS. 10A and 10B. The receptacle covers 136 protect the battery connection ports 132 and the charging module input port 134 from moisture, dirt, and other debris.

The expansion battery 108 generally includes a plurality of feet 138 extending downward from a bottom surface 140 of the housing 110 to secure the expansion battery in a stacked configuration or to raise the housing slightly off the floor or ground. An arc-shaped cutout 142 is shown extending through each of the feet 138 in a direction from the front sidewall 120 to a back sidewall 144 of the expansion battery 108. In various embodiments, the expansion battery 108 stacks on a power station 20 with the arc-shaped cutout 142 in the feet 138 sitting securely on the oval-shaped carrying handles 34 (FIG. 1) of the power station 20. While shown as arc-shaped in FIG. 5, the cutout 142 may have a different shape in various embodiments. In many embodiments, the shape of the cutout 142 will correspond to the shape of the carrying handles 34 such that the carrying handles 34 are able to safely support the expansion battery 108.

Referring now to FIG. 6, a rear view of the power station 20 connected to a pair of expansion batteries 146, 148 is shown, according to an embodiment of the invention. The expansion batteries 146, 148 are arranged similarly to the expansion battery 108 of FIG. 4, and thus, like elements therein are numbered identically to corresponding elements in the expansion battery 108 of FIG. 4. In FIG. 6, the external battery port 68 of the power station 20 is connected to a first expansion battery 146 and a second expansion battery 148. Each expansion battery 146, 148 may include a pair of battery connection ports 132 that connect to the power station 20 or the other expansion battery 146, 148 using a connection cable 150. Up to ten or more expansion batteries 146, 148 may be chained to the power station 20 to provide additional power. The battery system 112 of each expansion battery 146, 148 increases the battery or energy capacity (watt-hours (Wh) or joules (J)) or runtime of the power station 20. Alternatively, the expansion batteries 146, 148 could be configured to increase the running power or starting power of the power station 20. Each expansion battery 146, 148 also includes a charging module input port 134 for charging the expansion battery 146, 148.

As explained above, the control system 38 of the power station 20 is electrically coupled to the onboard battery system 36 and the external battery port 68 and may include a converter (not shown in FIG. 6) configured to convert a DC voltage to another DC voltage. As a result, the control system 38 of the power station 20 may utilize the converter to convert the DC voltage from the battery systems 112 of the expansion batteries 146, 148 into another DC voltage for distribution from the power station 20. The control system 38 of the power station 20 may additionally include a power inverter 42 to change DC power from each expansion battery 146, 148 to AC power for distribution from the power station 20. In another embodiment, the control system 114 of each expansion battery 146, 148 could provide a DC or AC power to the power station 20 that matches the requirements of any of the power output receptacles 50 of the power station 20. Accordingly, the control system 114 of each expansion battery 146, 148 may include a converter and/or inverter 152 to change DC power from the battery into an AC power supplied to the power station 20. The expansion batteries 146, 148 may also charge the onboard battery system 36 of the power station 20.

Each expansion battery 146, 148 may be paired to the power station 20 so that the control system 38 of the power station 20 can operate the expansion batteries 146, 148. Each expansion battery 146, 148 can be paired by connecting the expansion battery 146, 148 directly to the power station 20 and enabling a pairing feature on the power station 20. According to various embodiments of the invention, a user of the power station 20 may pair the expansion batteries 146, 148 to the power station 20 by performing a series of steps separately for each expansion battery 146, 148. Below is an example in which expansion battery 146 is paired to the power station 20.

In a first step, the user pairing the expansion battery 146 turns on the power station 20 and unplugs all electrical devices therefrom including any additional expansion batteries already connected and/or paired to the power station 20. In a second step, the user connects the expansion battery 146 being paired by connecting its connection cable 150 to the external battery port 68 of the power station 20. In a third step, the user holds down the overload reset button 62 (FIG. 1) of the power station 20 and presses the power button 56 (FIG. 3) of the power station 20 twice. Finally, the LED light 64 (FIG. 1) on the power station 20 will turn on and flash three times in a fourth step. If the LED light 64 does not turn on or flash three times, the user can repeat the second and third steps while ensuring that only the expansion battery 146 is connected to the power station 20. Once the expansion battery 146 is paired with the power station 20, the control system 38 of the power station 20 is able to communicate with and provide instructions to the control system 114 of the expansion battery 146.

In order to pair additional expansion batteries (for example, the expansion battery 148) to the power station 20, the user must disconnect the paired expansion battery 146 and repeat steps one through four above. Once the expansion batteries 146, 148 are paired to the power station 20, the expansion batteries 146, 148 will remain paired to the power station 20 until they are manually unpaired. In various embodiments, unpairing the expansion batteries 146, 148 may be performed by powering down or shutting down the expansion batteries 146, 148, by repeating steps one through four above, or by either method.

Pairing the expansion batteries 146, 148 allows the control system 38 of the power station 20 to discharge the battery system 36, 112 with the highest battery level before discharging the remaining batteries. In various embodiments, the battery level corresponds to a battery voltage and only the battery system or systems 36, 112 with the highest voltage will discharge until the voltage drops to approximately the same voltage level of the battery system or systems 36, 112 with the next highest battery voltage. That is, additional non-discharging battery systems 36, 112 will begin to discharge simultaneously with discharging battery systems 36, 112 when the voltages of the discharging battery systems 36, 112 approximate the voltages of the non-discharging battery systems 36, 112. In various embodiments, the voltages are approximate when the voltage levels or battery levels are within a specific percentage of each other such as 1%, 2%, 3%, 4%, or 5%, as non-limiting examples. However, in various embodiments, the voltages may be approximate when the voltage levels or battery levels are within a specific voltage level of the each other such as 1V or 2V, as non-limiting examples.

For example, the battery system 36, 112 with the highest battery level among the expansion batteries 146, 148 and the power station 20 could discharge first until the battery level is similar to the battery system 36, 112 that had the second highest battery level. The two battery systems 36, 112 will then discharge simultaneously to the level of the third highest battery level. Once all remaining battery levels are similar, each battery system 36, 112 will discharge simultaneously or at the same rate. Thus, the battery systems 112 of the expansion batteries 146, 148 may only begin discharging if their battery levels are equal to or greater than the battery level of the battery system 36 of the power station 20.

Referring now to FIG. 7A, a power station assembly 154 including the power station 20 and the expansion batteries 146, 148 of FIG. 6 is shown in a stacked configuration, according to an embodiment of the invention. FIG. 7A shows the power station assembly 154 with two expansion batteries 146, 148 stacked on the power station 20, though any suitable number of expansion batteries could be stacked on the power station (for example, up to ten or more). The first expansion battery 146 is stacked directly on the carrying handles 34 of the power station 20. The second expansion battery 148 is stacked on the carrying handles 116 of the first expansion battery 146 via stacking adaptors 158. The stacking adaptors 158 sit or snap onto the carrying handles 116 of the first expansion battery 146 to secure the second expansion battery 148 to the first expansion battery 146.

The control system 38 of the power station 20 may be configured to determine a number of expansion batteries 146, 148 electrically coupled to the power station 20, determine a battery level of each expansion battery 146, 148, and calculate a battery level available to the power station 20 by adding together the battery level of each expansion battery 146, 148. The control system 38 of the power station 20 may be programmed to sense each expansion battery 146, 148 coupled to the power station 20 by determining which expansion batteries 146, 148 are paired with the power station 20 and/or communicating with the control system 114 of each paired expansion battery 146, 148. The control system 38 may be programmed to determine the battery level of the battery system 112 of each expansion battery 146, 148 by reading the battery gauge 124 on each expansion battery 146, 148. The control system 38 may be programmed to add together the battery level of each expansion battery 146, 148 by adding together the percent battery level of each expansion battery 146, 148. In an alternative embodiment, the control system 38 may be configured to calculate a battery level available to the power station 20 by adding together the battery level of the onboard battery system 36 and the battery system 112 of each expansion battery 146, 148 electrically coupled to the power station 20. The automatic display 58 of the power station 20 operated by the control system 38 may display the available battery levels of the onboard battery system 36 and the battery systems 112 of the expansion batteries 146, 148.

The battery levels of the battery system 112 of each expansion battery 146, 148 electrically coupled to the power station 20 may comprise percent battery levels, and the battery level available to the power station 20 from battery system 36 and/or battery systems 112 may comprise a percent battery level relative to a capacity of the battery system 112 of a single expansion battery 146, 148 electrically coupled to the power station 20. The automatic display 58 may display the available battery level to the power station 20 as a percentage of a single expansion battery 146, 148 electrically coupled to the power station 20. That is, the automatic display 58 of the power station 20 may display that the total percent battery level is higher than 100% when the battery levels of the battery systems 112 of each expansion battery 146, 148 electrically coupled to the power station 20 have a total value greater than the capacity of the battery system 112 of a single expansion battery 146, 148. The automatic display 58 of the power station 20 may also display that the total percent battery level is higher than 100% when the battery levels of the battery system 36 of the power station 20 and each expansion battery 146, 148 electrically coupled to the power station 20 have a total value greater than the capacity of the battery system 112 of a single expansion battery 146, 148.

The control system 38 may calculate the power output and hours to empty for a particular load and operate the automatic display 58 to display the power output and/or hours to empty. The battery level available to the power station 20 is typically independent of an electrical load on the power station 20, but may be dependent on an electrical load on the power station 20 in some embodiments. Thus, the control system 38 may calculate the combined energy level of expansion batteries 146, 148 coupled to the power station 20 independent of or dependent on an electrical load on the power output receptacles 50 (FIG. 1).

Referring now to FIG. 7B, a pair of stacking adaptors between two expansion batteries is shown, according to an embodiment of the invention. Each stacking adaptor 158 has a lower surface with a semicircular cutout 160 extending a length of the stacking adaptor 158. The semicircular cutout 160 sits on rod-shaped carrying handles 116 of the first expansion battery 146. Each stacking adaptor 158 also has an oval-shaped upper surface 162 extending the length of the stacking adaptor 158. The second expansion battery 148 sits on the stacking adaptors 158 with the feet 138 of the second expansion battery 148 having arc-shaped cutouts 142 secured on the oval-shaped upper surface 162 of the stacking adaptors 158. Accordingly, the stacking adaptors 158 secure the feet 138 of the second expansion battery 148 to the rod-shaped carrying handles 116 of the first expansion battery 146 even if the feet 138 have a geometry that fits securely on oval-shaped carrying handles 34 (FIG. 1) of the power station 20. Although the handles 116 and feet 138 of the expansion batteries 146, 148 and the cutout 160 of the stacking adaptor 158 are described with particular shapes or configurations, in various embodiments, other shapes or configurations may be used. However, the handles 116 are typically designed for the comfort of a user.

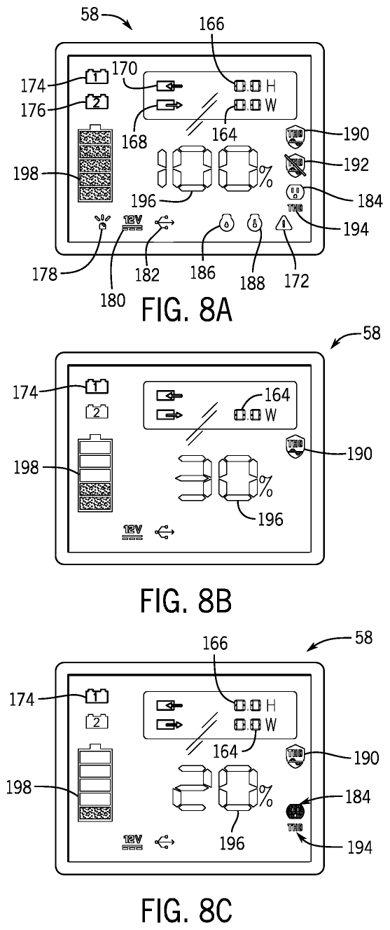

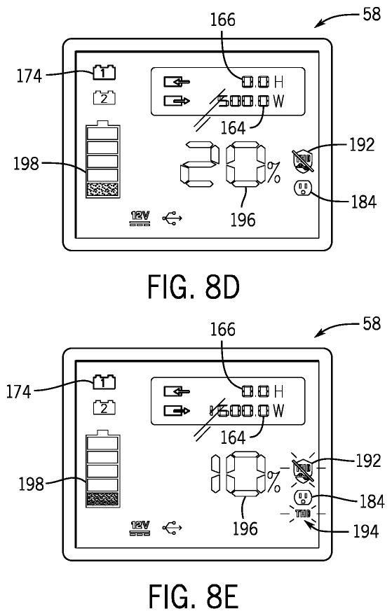

Referring now to FIGS. 8A-8E, the automatic display 58 for the power station 20 is shown, according to an embodiment of the invention. Referring specifically to FIG. 8A, the automatic display 58 generally displays a variety of information including available battery level, input/output power, and charge/discharge times, as well as faults, errors, and protection codes to help diagnose malfunctions of the power station 20 and any connected expansion batteries (for example, expansion batteries 146, 148 shown in FIG. 6). In various embodiments, the top of the automatic display 58 shows input and output information (for example, watts (W), volts (V), amps (A), hours to full/empty (H)) and operational status of any connected expansion batteries while the bottom of the display shows available battery level and icons indicating which power outlet receptacles 50 are currently being used, specific warnings, and/or other faults and functions.

The automatic display 58 may include an Output icon 164 which displays watts (W), hours until empty (H), AC volts (V), or AC amps (A) on a rotating basis or based on a user selection. The automatic display 58 may include an Input icon 166 which displays watts (W) or hours until full (H) on a rotating basis or based on a user selection. A Battery Out icon 168 indicates a discharging battery and a Battery In icon 170 indicates a charging battery. A Warning icon 172 flashes red when a battery or circuitry communication fault has occurred and is steady red when a battery management system (BMS) fault has occurred.

A Battery 1 icon 174 indicates that the automatic display 58 is showing battery information from the power station 20. When one or more expansion batteries are connected and paired to the power station, a Battery 2 icon 176 toggles on to indicate that the automatic display 58 is showing battery information from expansion batteries. The Battery 2 icon 176 may alternatively toggle on to indicate that the automatic display 58 is showing the combined battery information from the power station 20 and the connected expansion batteries. When expansion batteries are connected, the control system 38 of the power station 20 adds together the percent battery level of the battery system 112 of each expansion battery or the battery level of the battery system 112 of each expansion battery and the battery level of the onboard battery system 36, and the resulting hours until empty represents the total runtime available for the combined battery levels. Thus, when the Battery 2 icon 176 is illuminated, the control system 38 may operate the automatic display 58 to display the combined energy level of each expansion battery and/or the combined energy level of each expansion battery and the power station 20. However, in some embodiments, the automatic display 58 may include a Battery 3 icon (not shown) to display the combined energy level of each expansion battery and the power station 20.

An LED icon 178 indicates that the LED light 64 (FIG. 1) is on. A 12V icon 180 is steady blue to indicate that the 12V DC outlets 96, 98 (FIG. 3) are powered on and is steady red if a fault has occurred in the 12V DC outlets 96, 98. A USB icon 182 is steady blue to indicate that USB outlets 100, 102, 104 (FIG. 3) are powered on and is steady red if a fault has occurred in any of the USB outlets 100, 102, 104. A 120V icon 184 is steady blue to indicate that 120V AC outlets 106 (FIG. 3) are powered on and is steady red if an overload or fault has occurred in the inverter 42 (FIG. 1) or the 120V AC outlets 106.

A Low Temperature icon 186 is steady red if an internal temperature is too low. A High Temperature icon 188 is steady red if the internal temperature is too high. If the Battery 1 icon 174 is on, the Low Temperature icon 186 and the High Temperature icon 188 indicate that the power station 20 has experienced a low temperature event or a high temperature event, respectively. If the Battery 2 icon 176 is on, the Low Temperature icon 186 and the High Temperature icon 188 indicate that an expansion battery has experienced a low temperature event or a high temperature event, respectively.

As previously set forth above with respect to FIG. 7A, the control system 38 may operate the automatic display 58 to display the combined energy level of each expansion battery 146, 148 as a percentage of a maximum energy capacity of a battery system 112 of a single expansion battery 146, 148. Referring again to FIG. 8A with continued reference to FIG. 7A, the automatic display 58 typically includes a first fuel or battery gauge 196 that displays a percentage showing the percent battery level of the onboard battery system 36 of the power station 20 or of the battery systems 112 of the expansion batteries 146, 148. However, as similarly explained above, in some embodiments, the automatic display 58 may additionally or alternatively display the combined percent battery level of the battery systems 36, 112. When displaying expansion battery information, the first fuel gauge 196 reads higher than 100% when the combined energy levels of the battery systems 112 of the connected expansion batteries 146, 148 is higher than the maximum energy capacity of the battery system 112 of a single expansion battery 146, 148. The automatic display 58 may include a second fuel or battery gauge 198 that displays a number of bars (for example, 5 bars) that each represent a percent battery level of the onboard battery system 36 and/or the battery systems 112 of the expansion batteries 146, 148. When displaying expansion battery information, the second fuel gauge 198 will show as full when the battery levels of the battery systems 112 of all the connected expansion batteries 146, 148 and/or the battery system 36 of the power station 20 totals 100% or more of a capacity of the battery system 112 of a single expansion battery 146, 148.

As explained above, to protect sensitive electronics, the control system 38 of the power station 20 may be programmed with the THD shield 60 that safely stops the AC power output when the THD rises above a predetermined level or threshold (for example, 5%). The control system 38 will operate the automatic display 58 to activate various icons based according to the THD shield programming. When the THD shield 60 is enabled, the control system 38 operates the automatic display 58 to activate a THD Shield Enabled icon 190 to output a steady blue light. In that case, once the THD increases beyond the predetermined level, the control system 38 shuts off the AC power output of the power station 20 and operates the automatic display 58 to activate a THD icon 194 to output a steady red light. When the THD shield 60 is disabled, the control system 38 operates the automatic display 58 to activate a THD Shield Disabled icon 192 to output a steady blue light if the THD is below the predetermined level. Once the THD goes over the predetermined level, the control system 38 operates the automatic display 58 to activate the THD Shield Disabled icon 192 and the THD icon 194 to output a flashing blue light and a flashing red light, respectively, but allows the power station 20 to continue to provide an AC power output.

Referring to FIGS. 8B and 8C, FIG. 8B shows an embodiment of the automatic display 58 indicating that the THD shield 60 is enabled but the AC output is off, which may correspond to a default mode upon startup of the power station 20. The control system 38 of the power station 20 operates the automatics display 58 to cause THD Shield Enabled icon 190 to output a steady blue light and to not display the AC icon 184 (FIG. 8A). FIG. 8C shows an embodiment of the automatic display 58 indicating that the THD shield 60 is enabled and the THD is above a fault level. The control system 38 of the power station 20 operates the automatics display 58 to cause the THD Shield Enabled icon 190 to output a steady blue light, the THD icon 194 to output a steady red light, and the AC icon 184 to output a steady red light, which indicates that the AC power output is shut off or disabled due to a THD Fault.

Referring now to FIGS. 8D and 8E, FIG. 8D shows an embodiment of the automatic display 58 indicating that the THD shield 60 is disabled and the THD is below a fault level. The control system 38 of the power station 20 operates the automatic display 58 to cause the THD Shield Disabled icon 192 to output a steady blue light and the AC icon 184 to output a steady blue light, which indicates that the power station is enabled to supply an AC power output. FIG. 8E shows an embodiment of the automatic display 58 indicating that the THD shield 60 is disabled and the THD is above a fault level. The control system 38 of the power station 20 operates the automatic display 58 to cause the THD Shield Disabled icon 192 to output a flashing blue light, the THD icon 194 to output a flashing red light, and the AC icon 184 to output a steady blue light, which indicates that the power station 20 is enabled to provide the AC power output.

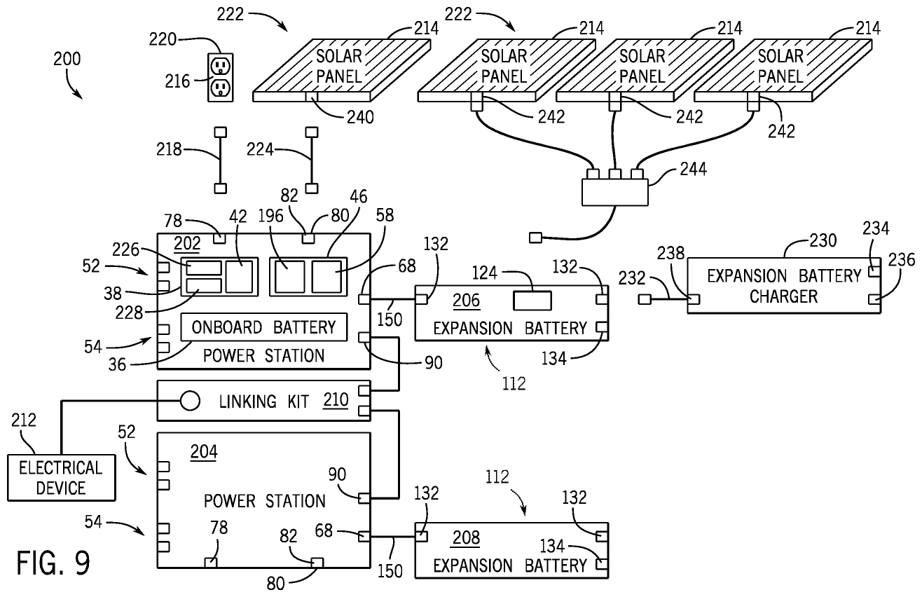

Referring now to FIG. 9, a block diagram of a power station assembly 200 is shown, according to an embodiment of the invention. The power station assembly 200 is shown with a first power station 202 coupled to a second power station 204 by a linking kit or module 210 that increases the available power output to an electrical device 212 powered by the power station assembly 200. The first and second power stations 202, 204 are arranged similarly to the power station 20 of FIG. 1, and hence, like elements therein are numbered identically to corresponding elements in the power station 20 of FIG. 1. A first expansion battery 206 is coupled to the first power station 202 and a second expansion battery 208 is coupled to the second power station 204. The first expansion battery 206 and the second expansion battery 208 increase the capacity or runtime of the power station assembly 200. The expansion batteries 206, 208 are arranged similarly to the expansion battery 108 of FIG. 4 and the expansion batteries 146, 148 of FIG. 6, and thus, like elements therein are numbered identically to corresponding elements in the expansion battery 108 of FIG. 4 and the expansion batteries 146, 148 of FIG. 6.

The power stations 202, 204 may each include one or more linking kit connection ports 90 configured to receive connections to the linking kit 210. The linking kit 210 may be used as a parallel link to couple together the AC power outputs from the linking kit connection ports 90 of the two power stations 202, 204 to increase output current or a series link to couple together the AC power outputs from the linking kit connection ports 90 of the two power stations 202, 204 to increase output voltage. The power stations 202, 204 are also shown with an external battery port 68 configured to connect expansion batteries 206, 208, a DC power inlet receptacle 80 configured to connect to a DC power source 222 and an AC power inlet receptacle 78 configured to connect to an AC power source 216. The power stations 202, 204 may also include DC power output receptacles 52 and AC power output receptacles 54 configured to power electrical devices coupled to the power station 202, 204.

The AC power inlet receptacle 78 couples to the AC power source 216 using an AC cord 218. The AC power source 216 may be a traditional wall outlet 220 coupled to the utility grid. The AC power inlet receptacle 78 may support AC fast charging (for example, at 120V AC, 50 Hz/60 Hz, 4.5 A MAX). The DC power inlet receptacle 80 may include an APP input port 82 configured to couple to the DC power source 222 using an APP cord 224. The DC power source 222 may include one or more solar panels 214. The APP input port 82 may support DC fast charging (for example, at 10V-28V DC, 25 A MAX).

The power stations 202, 204 also include a control system 38 including an inverter 42, a processor 226 and memory 228. While the inverter 42 is illustrated as part of the control system 38, the inverter 42 may be controlled by the control system 38 as a separate element therefrom. The processor 226 may be one or more computer processors or microprocessors capable of executing a computer program having instructions including executable code. The executable code may be stored on the memory 228 which may include any suitable non-transitory media that can store executable code for use by the processor 226 to perform the presently disclosed techniques. The memory 228 may be any suitable type of computer-readable media that can store the executable code, data, analysis of the data, or the like. The power stations 202, 204 may also include a control panel 46 having an automatic display 58 and a battery gauge 196.

An expansion battery charger or charging module 230 is configured to charge the expansion batteries 206, 208. The expansion battery charging module 230 may receive power from the AC power source 216 and/or the DC power source 222 and supply the power to one expansion battery 206, 208 using a power cord 232. The expansion battery charging module 230 includes an AC input port 234, an APP input port 236, and a power DC output port 238. The AC input port 234 is configured to couple to an AC power source such as, for example, the AC power source 216 using the AC cord 218. The APP input port 236 is configured to couple to a DC power source such as, for example, the DC power source 222 using the APP cord 224.

The expansion batteries 206, 208 may include a charging module input port 134 that connects to the power output port 238 of the expansion battery charging module 230 using the power cord 232. The expansion batteries 206, 208 may also include a pair of battery connection ports 132 that couple to a battery connection port 132 of another expansion battery 206, 208 or to the external battery port 68 of a power station 202, 204. A connection cable 150 may electrically couple the expansion batteries 206, 208 to the power stations 202, 204 when coupled to one battery connection port 132 and one external battery port 68. The expansion batteries 206, 208 may each be connected to one or more additional expansion batteries (not shown in FIG. 9) to increase the battery capacity available to the power stations 202, 204.

In various embodiments, the solar panels 214 of the DC power source 222 may be rated between 10V-28V with MC4 or APP connectors and may power one or more of the power stations 202, 204 or expansion batteries 206, 208 via the expansion battery charging module 230. The solar panels 214 may include APP connectors 240 that can be coupled directly to the APP input ports 82 of the power stations 202, 204 or the APP input port 236 of the expansion battery charging module 230. The solar panels 214 may alternatively include MC4 connectors 242 that can be connected to the APP input ports 82, 236 using an MC4 to APP solar charge harness 244. The solar charge harness 244 may have an APP plug connectable to the power stations 202, 204 and the expansion battery charging module 230 with MC4 connections such as, for example, three MC4 connections to couple up to three or more solar panels 214 having MC4 connectors 242.

In some embodiments of the invention, the capacity of the onboard battery system 36 and/or each expansion battery 206, 208 could have an approximate (within plus or minus 5%) capacity of 1600 Wh or 3200 Wh. The onboard battery system 36 and/or each battery system 112 of the expansion batteries 206, 208 may have a rated output voltage of approximately 46.8V and a max output voltage of approximately 54.6V-55V, although the battery systems 36, 112 could have any suitable voltage rating such as 12V, 24V, or 48V, as non-limiting examples. The percent battery level of the onboard battery systems 36, 112 may correspond to the battery voltage. As a non-limiting example, 100% battery level could correspond to 55V, and 0% battery level could correspond to 38V. In some embodiments, when power stations 202, 204 operate at full load, they will not reach 5% THD until the voltage drops to 42.57V with 17% battery capacity, and when power stations 202, 204 operate at full load with double the battery capacity, they will not reach 5% THD until the voltage drops to 42.70V with 11% battery capacity. In various embodiments, the power stations 202, 204 may each provide single phase AC power at 60 Hz with a current rating of approximately 13.3 A at 120V.

Referring now to FIGS. 10A-10B, the charging module 230 for expansion batteries, such as, for example, the expansion battery 108 of FIG. 4, the expansion batteries 146, 148 of FIG. 6, and the expansion batteries 206, 208 of FIG. 9, is shown, according to an embodiment of the invention. The expansion battery charging module 230 is a power converter that changes power from an AC power source and/or a DC power source into a form required to charge expansion batteries. The expansion battery charging module 230 includes a generally rectangular housing 246 having a first end 248 opposite a second end 250 with the AC input port 234 and the APP input port 236 in the first end 248 and the power output port 238 in the second end 250. A power cord 232 is couplable between the power output port 238 and an expansion battery. The AC input port 234 may support AC fast charging from a wall outlet (for example, at 120V AC, 50 Hz/60 Hz, 4.5 A MAX). The APP input port 236 may support DC fast charging from a DC power source (for example, at 10V-28V DC, 25 A MAX). In various embodiments, the expansion battery charging module 230 outputs power at 55V DC with a maximum current of 8 A or 16 A to charge an expansion battery. A plurality of cooling vents 252 are located in the first end 248 and the second end 250 for cooling air to flow through the housing 246.

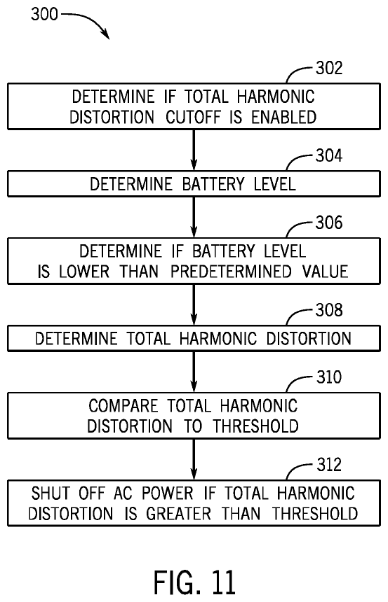

Referring now to FIG. 11 with continued reference back to FIG. 9, a flow diagram of a process 300 used to control THD of a power station is illustrated, in accordance with an embodiment of the invention. The process 300 will be described with respect to the power station 202 of the power station assembly 200 of FIG. 9, but the process 300 is equally application to the power station 20 of FIG. 1 or the power station 204 of the power station assembly 200 of FIG. 9. Also, as similarly explained above, the term energy level is used interchangeably with the terms battery level, charge level, and state of charge.

The process 300 begins at STEP 302 by determining that a user has selected automatic THD shutoff control of the power station 202. The power station 202 includes the onboard battery system 36, one or more AC power output receptacles 54, the inverter 42 powered by the onboard battery system 36 to provide AC power to the AC power output receptacles 54, and the control system 38 to operate the power station 202. The process continues at STEP 304 by determining a battery level of the onboard battery system 36 of the power station 202. The THD is generally higher when the battery level is low and the AC load on the power station 202 is high. Thus, the control system 38 may be programmed to determine a battery level of the onboard battery system 36 and the load on the power station 202. A detailed explanation of how the control system 38 of the power station 202 may determine the battery level of the onboard battery system 36 and the load on the power station 202 is provided above in more detail with respect to FIG. 1, and that explanations is applicable to the process 300 as well.

The process 300 continues at STEP 306 by determining if the battery level is below a preset value. The control system 38 may be programmed to determine that a voltage level of the onboard battery system 36 indicates the battery level is below a preset battery level. In various embodiments, the preset battery level is approximately 30% (that is, between 28.5%-31.5%) of the capacity of the onboard battery system 36. However, the preset battery level could be any suitable battery level such as 15%, 20%, 25%, 35%, or 40%, as non-limiting examples.

The process 300 continues at STEP 308 by determining a THD of the power station 202 when AC power is output through the AC power output receptacles 54. The control system 38 may operate the automatic display 58 to indicate whether the THD is above the preset level. The THD may be determined using predetermined relationships between THD and battery level for a particular load on the power station 202. The predetermined relationships can be determined by operating the power station 202 at each load and measuring the THD as the battery level drops. Predetermined relationships may be stored as lookup tables in the memory 228 that correlate THD to battery level for each load. When a load is placed on the power station 202, the control system 38 can access the predetermined relationships for the load and determine if the preset THD level is exceeded based on the remaining battery level. However, the control system 38 may either alternately or additionally determine the THD by calculating the THD using direct measurements of the output waveform from the inverter 42.

The process 300 continues at STEP 310 by comparing the determined THD to the preset THD threshold. The THD threshold may be a predetermined THD value selected to ensure sensitive electronics are not damaged by increasing THD from the AC power output receptacles 54 as the onboard battery system 36 depletes. In various embodiments, the predetermined THD level is approximately 5% (between 4.75%-5.25%) but could be any suitable THD level such as 2%, 3%, 4%, 6%, 7%, or 8%, as non-limiting examples. The process 300 concludes at step 312 by shutting off the AC power to the AC power output receptacles 54 when the THD is above the predetermined level. Accordingly, the control system 38 may be programmed to automatically shut off the AC power to the AC power output receptacles 54 and operate the automatic display 58 to indicate that the AC power to the AC power output receptacles 54 is shut off. A detailed explanation of how the control system 38 may operate the automatic display 58 to indicate the effect of THD on a power system and AC power shut off is provided above in more detail with respect to FIGS. 7A-8C, and that explanation is also applicable to the process 300.

A technical contribution for the disclosed system and method is that it provides for a computer implemented method of determining and controlling THD of the inverter power station 202. In various embodiments, a non-transitory computer readable storage medium 228 has stored thereon a computer program for controlling the power output of the power station 202 based on a THD of the power station 202. The computer program may include instructions that, when executed by a processor 226, cause the processor 226 to calculate the THD of the power station 202 when AC power is output through at least one of the AC power output receptacles 54 of the power station 202 and shut off the AC power to each AC power output receptacle 54 when the THD is above a preset level (e.g., approximately 5%). The instructions may cause the processor 226 to determine that a battery level of the power station 202 is lower than a preset battery level prior to or as a condition for shutting off AC power to at least one of the AC power output receptacles 54 and to operate an automatic display 58 to indicate whether the THD is above the preset level and whether the AC power output is shut off.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not listed may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Beneficially, embodiments of the invention provide a system and method for displaying and controlling a total harmonic distortion of a power station. The power station may include a control system that determines an energy level of an onboard battery and the THD from an inverter powered by the onboard battery. If the battery level has been depleted below a predetermined value and the THD is higher than a threshold THD, the control system may automatically shut off AC power to prevent damage to electronics powered by the power station and sensitive to THD higher than the threshold THD. The control system may operate a digital display to indicate whether the THD is higher than a threshold value, whether a THD shield is enabled, and/or whether the AC output is shut off due to a THD fault.

Therefore, according to one embodiment of the invention, a power station includes an inverter to convert DC power to AC power, an onboard battery system configured to provide DC power to the inverter, and at least one AC power output receptacle configured to receive AC power from the inverter and provide the AC power to a load. The power station also includes a control system programmed to determine a total harmonic distortion (THD) of the AC power provided to the at least one AC power output receptacle from the inverter and a display operated by the control system to indicate the THD.

According to another embodiment of the invention, a non-transitory computer readable storage medium has stored thereon a computer program for controlling the power output of a power station based on a total harmonic distortion (THD) of the power station. The computer program includes instructions that cause a processor to determine the THD of the power station when AC power is output through at least one power output receptacle of the power station and to shut off the AC power to the at least one power output receptacle when the THD is above a preset level.

According to yet another embodiment of the invention, a power station includes an onboard battery system, at least one power output receptacle, an inverter powered by the onboard battery system to provide AC power to the at least one power output receptacle, and a control system. The control system is programmed to determine a total harmonic distortion (THD) of the power station when AC power is output through the at least one power output receptacle and to automatically shut off the AC power to the at least one power output receptacle when the THD is above a preset level.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. The singular forms ‘a,’ ‘an,’ and ‘the’ in the claims include plural reference unless the context clearly dictates otherwise. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A power station comprising:
an inverter to convert DC power to AC power;
an onboard battery system configured to provide DC power to the inverter;
at least one AC power output receptacle configured to receive AC power from the inverter and provide the AC power to a load;
a control system programmed to determine a total harmonic distortion (THD) of the AC power provided to the at least one AC power output receptacle from the inverter; and
a display operated by the control system to indicate the THD.

2. The power station of claim 1 wherein the control system is programmed to operate the display to indicate whether the THD is above a predetermined level.

3. The power station of claim 1 wherein the control system is programmed with a THD shield to automatically shut off the AC power output from the at least one AC power output receptacle when the THD is above a predetermined level.

4. The power station of claim 3 further comprising a user input control to selectively enable the THD shield.

5. The power station of claim 4 wherein the control system is further programmed to operate the display to indicate whether the THD shield is enabled or disabled.

6. The power station of claim 1 wherein the control system is programmed with a THD shield to automatically shut off the AC power output from the at least one AC power output receptacle when the onboard battery system has a battery level below a predetermined battery level and the THD is above a predetermined THD level.

7. The power station of claim 6 wherein:
the predetermined battery level is approximately 30% of a battery level of the onboard battery system when the onboard battery system is fully charged; and
the predetermined THD level is approximately 5%.

8. The power station of claim 7 wherein the predetermined THD level of approximately 5% is a THD level for voltage harmonics in the AC power from the inverter.

9. The power station of claim 1 wherein the control system is programmed to determine the THD by:
determining a battery level available to the power station;
determining the load on the power station; and
obtaining the THD from a lookup table in a memory of the power station based on the determined battery level and load, the lookup table including THD values for predetermined relationships between battery level and loads on the power station.

10. A non-transitory computer readable storage medium having stored thereon a computer program for controlling the power output of a power station based on a total harmonic distortion (THD) of the power station, the computer program comprising instructions that cause a processor to:
determine the THD of the power station when AC power is output through at least one power output receptacle of the power station; and
shut off the AC power to the at least one power output receptacle when the THD is above a preset level.

11. The non-transitory computer readable storage medium of claim 10 wherein the preset level is approximately 5% THD.

12. The non-transitory computer readable storage medium of claim 10 wherein the instructions further cause the processor to operate a user display panel to indicate whether the THD is above the preset level.

13. The non-transitory computer readable storage medium of claim 10 wherein the instructions further cause the processor to determine that a battery level of an onboard battery system of the power station is lower than a preset battery level as a condition for shutting off AC power to the at least one power output receptacle.

14. The non-transitory computer readable storage medium of claim 10 wherein the instructions further cause the processor to determine that a user has selected automatic THD shutoff as a condition for shutting off AC power to the at least one power output receptacle.

15. A power station comprising:
an onboard battery system;
at least one power output receptacle;
an inverter powered by the onboard battery system to provide AC power to the at least one power output receptacle; and
a control system programmed to:
determine a total harmonic distortion (THD) of the power station when AC power is output through the at least one power output receptacle; and
automatically shut off the AC power to the at least one power output receptacle when the THD is above a preset level.

16. The power station of claim 15 wherein the onboard battery system is a lithium-ion battery.

17. The power station of claim 15 wherein the control system is programmed to determine that a battery level of the onboard battery system is below a preset battery level prior to automatically shutting off the AC power to the at least one power output receptacle.

18. The power station of claim 17 wherein the power station further comprises:
an expansion battery port electrically coupled to the inverter, and
at least one expansion battery couplable to the expansion battery port.

19. The power station of claim 15 further comprising an overload reset switch to manually restore AC power to the at least one power output receptacle.

20. The power station of claim 15 further comprising a user display operated by the control system to indicate whether the THD is above the preset level and whether the AC power to the at least one power output receptacle is shut off.

21. The power station of claim 15 further comprising a pair of parallel AC power output receptacles couplable to a parallel link kit configured to combine the AC power with an AC power of another power station.
